(19) United States
(12) Patent Application Publication
(10) Pub. No.: US 2020/0024484 A1
(43) Pub. Date: Jan. 23, 2020

(54) POLISHING AGENT FOR SYNTHETIC QUARTZ GLASS SUBSTRATE, METHOD FOR MANUFACTURING THE POLISHING AGENT, AND METHOD FOR POLISHING SYNTHETIC QUARTZ GLASS SUBSTRATE

(71) Applicant: SHIN-ETSU CHEMICAL CO., LTD., Tokyo (JP)

(72) Inventors: Mitsuhito TAKAHASHI, Annaka-shi (JP); Yoshihiro NOJIMA, Annaka-shi (JP)

(73) Assignee: SHIN-ETSU CHEMICAL CO., LTD., Tokyo (JP)

(21) Appl. No.: 16/497,586

(22) PCT Filed: Mar. 19, 2018
(86) PCT No.: PCT/JP2018/010756

§ 371 Date: Sep. 25, 2019

(30) Foreign Application Priority Data
Apr. 10, 2017 (JP) 2017-077752

(51) Int. Cl. C09G 1/02; C09K 3/14; C03C 3/06; C03C 15/02

(52) U.S. Cl. CPC C09G 1/02; C09K 3/1436; C03C 3/06; C03C 2204/00; C03C 2201/02; C03C 2203/50; C03C 15/025

(57) ABSTRACT

A polishing agent for a synthetic quartz glass substrate contains polishing particles and water. The polishing particles contain silica particles as base particles, and composite oxide particles of cerium and at least one rare earth element selected from trivalent rare earth elements other than cerium are supported on surfaces of the base particles. This provides a polishing agent for a synthetic quartz glass substrate, the polishing agent having high polishing rate and being capable of sufficiently reducing generation of defects due to polishing.

### TECHNICAL FIELD

The present invention relates to a polishing agent for a synthetic quartz glass substrate, a method for manufacturing the polishing agent, and a method for polishing a synthetic quartz glass substrate.

### BACKGROUND ART

In recent years, along with pattern miniaturization by photolithography, synthetic quartz glass substrates are required to have more stringent qualities such as defect density, defect size, surface roughness, and flatness. Above all, regarding defects on the substrates, higher quality is required as integrated circuits become finer and magnetic media have higher capacity.

In view of this, a polishing agent for a synthetic quartz glass substrate is strongly required that the quartz glass substrate after polishing should have small surface roughness, and that the quartz glass substrate should have few surface defects such as a scratch on the polished surface, so as to improve the quality of the quartz glass substrate after polishing. Moreover, in view of productivity improvement, it is also required to increase the polishing rate of the quartz glass substrate.

Conventionally, in general, a silica-based polishing agent has been studied as a polishing agent for polishing a synthetic quartz glass. Silica-based slurry is produced by subjecting silica particles to grain growth through thermal decomposition of silicon tetrachloride and adjusting pH with an alkaline solution, which contains no alkali metal such as sodium. For example, Patent Document 1 describes that defects can be reduced by using high-purity colloidal silica around neutrality. However, considering the isoelectric point of colloidal silica, colloidal silica is unstable around neutrality, and there is concern that the particle size distribution of colloidal silica abrasive grains varies during polishing, thereby bringing about a problem that the colloidal silica cannot be stably used. In addition, it is difficult to circulate and repeatedly use the polishing agent, which thus has to be disposed after one-time use, resulting in an economically unfavorable problem. Moreover, Patent Document 2 describes that defects can be reduced by using a polishing agent containing an acid and colloidal silica having an average primary particle diameter of 60 nm or less. However, these polishing agents are insufficient to satisfy current requirements, and further development is required.

Meanwhile, ceria (CeO₂) particles are known as a strong oxidizing agent and have chemically active characteristics. It is believed that the redox between Ce(IV) and Ce(III) of ceria is effective in improving the polishing rate of an inorganic insulator such as glass. Introducing oxygen defect by substituting part of tetravalent ceria with a different trivalent metal element can increase the reactivity with an inorganic insulator such as glass, and effectively improves the polishing rate of an inorganic insulator such as glass in comparison with colloidal silica.

However, typical ceria-based polishing agents use dry ceria particles. The dry ceria particles have irregular crystal shapes, and the application to a polishing agent results in a problem that defects such as a scratch are easily generated on the surface of the quartz glass substrate in comparison with spherical colloidal silica. Moreover, the dispersion stability of ceria-based polishing agents is lower than that of colloidal silica, causing a problem that the particles are likely to precipitate.

### CITATION LIST

### Patent Literature

### Patent Document 1: Japanese Unexamined Patent Publication (Kokai) No. 2004-98278

### Patent Document 2: Japanese Unexamined Patent Publication (Kokai) No. 2007-213020

### Patent Document 3: Japanese Unexamined Patent Publication (Kokai) No. 2006-167817

Patent Document 4: Japanese Examined Patent Publication (Koukoku) No. S63-27389

### SUMMARY OF INVENTION

### Technical Problem

When wet ceria particles are solely used instead of dry ceria particles as a ceria-based polishing agent for a synthetic quartz glass substrate, defects such as a scratch are reduced more than when dry ceria particles are used, but the reduction is not sufficient to meet the requirement, and the polishing rate also does not meet the requirement. Patent Document 3 describes that the polishing rate can be accelerated by using a polishing agent which uses colloidal silica, and which contains a polymer having a sulfonic acid group, such as an acrylic acid/sulfonic acid copolymer. However, the addition of such a polymer to a ceria-based polishing agent is still insufficient to achieve the currently required polishing rate, and further improvement of the polishing rate is required.

Furthermore, Patent Document 4 describes that the polishing rate can be accelerated by using a polishing agent containing 40 to 99.5% by weight of ceric oxide and 0.5 to 60% by weight of at least one of other rare earth elements selected from the group consisting of lanthanide and yttrium, the oxide of which is colorless. However, the resulting oxide has an average particle diameter of 0.5 to 1.7 μm. This particle size is so large that there are concerns that: the surface accuracy after polishing may be a problem; and the large particle size may cause a problem in the dispersion stability.

As has been described above, the conventional techniques have problems that it is difficult to achieve both the reduction in polishing defects and the sufficient improvement in polishing rate.

The present invention has been accomplished in view of the problems as described above. An object of the present invention is to provide: a polishing agent for a synthetic quartz glass substrate, the polishing agent having high polishing rate and being capable of sufficiently reducing generation of defects due to polishing; and a method for manufacturing such a polishing agent. Another object of the present invention is to provide a method for polishing a synthetic quartz glass substrate with high polishing rate while sufficiently reducing generation of defects.

### Solution to Problem

To achieve the object, the present invention provides a polishing agent for a synthetic quartz glass substrate, comprising polishing particles and water, wherein

the polishing particles comprise silica particles as base particles, and

composite oxide particles of cerium and at least one rare earth element selected from trivalent rare earth elements other than cerium are supported on surfaces of the base particles.

The polishing agent for a synthetic quartz glass substrate contains such polishing particles as described above, and enables high polishing rate while sufficiently inhibiting generation of defects such as a scratch in comparison with cases of using cerium-lanthanum composite oxide particles alone, using the silica particles alone, or using a the cerium-lanthanum composite oxide particles and the silica particles both of which are simply mixed together. As the composite oxide particles supported on the silica particle surfaces are formed from a composite oxide of cerium and a trivalent rare earth element other than cerium, oxygen defect is introduced to the supported composite oxide particles. As a result, the valence of tetravalent ceria in the composite oxide particles is likely to change. This improves the activity and the reactivity with the surface of a synthetic quartz glass substrate. Thus, the polishing rate is improved. In addition, when the silica particles are used as the base particles, the particles have spherical shapes; further, the dispersion stability is improved in comparison with the case of ceria particles. Thus, it is possible to inhibit defect generation on a synthetic quartz glass substrate due to polishing.

Here, preferably, the base particles comprise amorphous silica particles, and the amorphous silica particles have an average particle diameter of 60 nm or more and 120 nm or less.

When the base particles made of amorphous silica particles have an average particle diameter of 60 nm or more, the polishing rate for a synthetic quartz glass substrate can be improved. Moreover, when the average particle diameter is 120 nm or less, polishing damage such as a scratch can be particularly inhibited.

Preferably, the composite oxide particles are a composite oxide of cerium and lanthanum, and a molar ratio of cerium/lanthanum is 1.0 to 4.0.

When the molar ratio of cerium/lanthanum in the composite oxide particles is within the range of 1.0 to 4.0, the reactivity between the composite oxide particles and the surface of a synthetic quartz glass substrate is further improved, and the polishing rate is more improved.

Additionally, the composite oxide particles preferably have particle diameters of 1 nm or more and 20 nm or less.

When the particle diameters of the composite oxide particles are as large as 1 nm or more, the polishing rate for a synthetic quartz glass substrate can be sufficiently ensured. Moreover, when the particle diameters are 20 nm or less, the number of the composite oxide particles that can be supported on the base particles is increased, and the polishing rate for a synthetic quartz glass substrate is further improved.

In addition, a concentration of the polishing particles is preferably 5 parts by mass or more and 30 parts by mass or less per 100 parts by mass of the polishing agent for a synthetic quartz glass substrate.

When the concentration of the polishing particles is 5 parts by mass or more per 100 parts by mass of the polishing agent for a synthetic quartz glass substrate, favorable polishing rate is achieved. Moreover, when the concentration is 30 parts by mass or less, the storage stability of the polishing agent can be more increased.

Preferably, the inventive polishing agent for a synthetic quartz glass substrate further comprises an additive, wherein a concentration of the additive is 0.1 parts by mass or more and 5 parts by mass or less per 100 parts by mass of the polishing particles.

When the polishing agent for a synthetic quartz glass substrate contains an additive, the polishing particles easily disperse in the polishing agent and do not easily generate secondary particles having large particle diameters, so that polishing damage can be further inhibited. Moreover, when the concentration of the additive is 0.1 parts by mass or more per 100 parts by mass of the polishing particles, the polishing particles more stably disperse in the polishing agent and do not easily form aggregated particles having large particle diameters. When the concentration is 5 parts by mass or less, the additive does not impede polishing, and can prevent a reduction in the polishing rate.

Further, the inventive polishing agent for a synthetic quartz glass substrate preferably has a pH of 3.0 or more and 8.0 or less.

When the pH of the polishing agent for a synthetic quartz glass substrate is 3.0 or more, the polishing particles more stably disperse in the polishing agent. When the pH is 8.0 or less, the polishing rate can be further improved.

Furthermore, the present invention provides a method for polishing a synthetic quartz glass substrate, comprising a rough polishing step and a finish polishing step after the rough polishing step, wherein the inventive polishing agent for a synthetic quartz glass substrate is used in the finish polishing step for final polishing.

Such a polishing method using the inventive polishing agent for a synthetic quartz glass substrate enables high polishing rate and can inhibit generation of defects due to polishing.

Furthermore, the present invention provides a method for manufacturing a polishing agent for a synthetic quartz glass substrate, wherein

the polishing agent comprises water and polishing particles comprising silica particles as base particles,

composite oxide particles of cerium and at least one rare earth element selected from trivalent rare earth elements other than cerium are supported on surfaces of the base particles, and

the method comprises:
a step of producing the polishing particles, the step comprising
a substep of preparing a solution A in which the silica particles are dispersed in a dispersion medium,
a substep of preparing a basic solution as a solution B,
a substep of preparing a solution C in which a cerium salt and a salt of at least one rare earth element selected from trivalent rare earth elements other than cerium are dissolved as precursors of the composite oxide particles,
a substep of mixing the solution A, the solution B, and the solution C to precipitate the composite oxide particles from the precursors of the composite oxide particles, so that the precipitated composite oxide particles are supported on the silica particles, and
a substep of subjecting a solution containing the silica particles on which the composite oxide particles are supported to a heat treatment for 1 hour or more at a solution temperature of 60° C. or more and 100° C. or less; and

a step of manufacturing a polishing agent for a synthetic quartz glass substrate, the polishing agent comprising the produced polishing particles and water.

Such a manufacturing method can manufacture the polishing agent for a synthetic quartz glass substrate as described above.

### Advantageous Effects of Invention

The inventive polishing agent for a synthetic quartz glass substrate and the polishing method using the polishing agent enable sufficient polishing rate and sufficient inhibition of defect generation on the surface of a synthetic quartz glass substrate in polishing the synthetic quartz glass substrate. As a result, the productivity and yield can be improved to produce synthetic quartz glass substrates. In addition, particularly, when the inventive polishing agent for a synthetic quartz glass substrate is used in a finish polishing step in a process for producing a synthetic quartz glass substrate, finer semiconductor devices can be obtained. Moreover, the inventive method for manufacturing a polishing agent for a synthetic quartz glass substrate makes it possible to manufacture the above-configured polishing agent for a synthetic quartz glass substrate.

### BRIEF DESCRIPTION OF DRAWINGS

FIG. 1 is a schematic diagram showing an example of a polishing apparatus usable in a method for polishing a synthetic quartz glass substrate of the present invention.

### DESCRIPTION OF EMBODIMENTS

Hereinafter, embodiments of the present invention will be described, but the present invention is not limited thereto.

As described above, the polishing agent for a synthetic quartz glass substrate (hereinafter, also simply referred to as “polishing agent”) of the present invention contains polishing particles and water, the polishing particles contain silica particles as base particles, and composite oxide particles of cerium and at least one rare earth element selected from trivalent rare earth elements other than cerium are supported on surfaces of the base particles.

In the inventive polishing agent for a synthetic quartz glass substrate, such silica particles carrying the composite oxide particles on the particle surfaces are used as the polishing particles. This inhibits generation of defects such as a damage due to polishing and enables polishing at high polishing rate.

The supported composite oxide particles have oxygen defect in the crystal structure. Hence, in comparison with ceria particles having a stable single crystal structure, the supported composite oxide particles have highly active surfaces. Thus, in the polishing process, a chemical reaction readily occurs between the composite oxide particles and the surface of a synthetic quartz glass substrate. As a result, the surface of the synthetic quartz glass is modified, which presumably promotes the polishing. Additionally, since silica particles having favorable dispersion stability are employed as the base particles, the dispersibility of the slurry is improved, and the particle aggregation during polishing is reduced, so that polishing damages such as defect are presumably reduced.

Hereinafter, detailed explanation is given for the components, components that can be optionally added, and polishing a synthetic quartz glass substrate with the inventive polishing agent.

As mentioned above, the inventive polishing agent contains the polishing particles in which silica particles serve as the base particles, and composite oxide particles of cerium and at least one rare earth element selected from trivalent rare earth elements other than cerium are supported on the surfaces of the base particles.

In the present invention, the base particles preferably contain amorphous silica particles. The amorphous silica particles are generally spherical, so that polishing damage such as scratch can be reduced. Moreover, since the use of crystalline silica particles is restricted by law, it is preferable to use amorphous silica particles.

The silica particles (particularly, amorphous silica particles) used as the base particles in the present invention preferably have an average particle diameter within a range of 60 nm or more and 120 nm or less. The average particle diameter is more preferably within a range of 70 nm or more and 110 nm or less, further preferably within a range of 80 nm or more and 100 nm or less. In this event, when the base particles made of the silica particles have an average particle diameter of 60 nm or more, the polishing rate for a synthetic quartz glass substrate is improved. When the average particle diameter is 120 nm or less, polishing damage such as a scratch can be further reduced. The silica particles as the base particles are not particularly limited, and commercially available silica particles can be used. Examples of the silica particles include colloidal silica, fumed silica, and the like. The silica particles are particularly preferably colloidal silica.

Moreover, the ceria composite oxide particles supported on the base particles are a composite oxide of cerium and a trivalent rare earth element other than cerium. The trivalent rare earth element other than cerium includes yttrium (Y), lanthanum (La), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Tb), lutetium (Lu), and the like. Among these, lanthanum is suitably usable because the raw material is readily available.

The amount of the trivalent rare earth element other than cerium contained in the composite oxide particles is preferably 10 mol % to 60 mol %, more preferably 20 mol % to 50 mol %. When the content of the trivalent rare earth element other than cerium contained in the composite oxide particles is 10 mol % or more and 60 mol % or less, the effect of improving the polishing rate for a synthetic quartz glass substrate is more increased. Moreover, when the content is 20 mol % or more and 50 mol % or less, the polishing rate for a quartz glass substrate is further improved.

The composite oxide particles are particularly preferably a composite oxide of cerium and lanthanum, and the molar ratio of cerium/lanthanum is preferably 1.0 to 4.0. When the molar ratio of cerium/lanthanum in the composite oxide particles is within the range of 1.0 to 4.0, the reactivity between the composite oxide particles and the surface of a synthetic quartz glass substrate is further improved, and the polishing rate is more improved.

The composite oxide particles supported on the silica base particles preferably have particle diameters within a range of 1 nm or more and 20 nm or less, more preferably within a range of 3 nm or more and 15 nm or less, and further preferably within a range of 5 nm or more and 10 nm or less. When the particle diameters of the composite oxide particles are as large as 1 nm or more, the polishing rate for a synthetic quartz glass substrate can be sufficiently ensured. Moreover, when the particle diameters are 20 nm or less, the number of the composite oxide particles that can be supported on the base particles is increased, and the polishing rate for a synthetic quartz glass substrate is more improved.

The concentration of the polishing particles including the base particles and the composite oxide particles used in the present invention is not particularly limited, but is preferably 0.1 parts by mass or more, more preferably 1 part by mass or more, and further preferably 5 parts by mass or more, per 100 parts by mass of the polishing agent from the viewpoint that favorable polishing rate for a synthetic quartz glass substrate is achieved. Moreover, the upper limit concentration of the polishing particles is preferably 50 parts by mass or less, more preferably 40 parts by mass or less, and further preferably 30 parts by mass or less, from the viewpoint that the storage stability of the polishing agent can be more increased.

The inventive polishing agent is, as described above, a polishing agent for a synthetic quartz glass substrate, containing: water and polishing particles containing silica particles as base particles; and composite oxide particles of cerium and at least one rare earth element selected from trivalent rare earth elements other than cerium, the composite oxide particles being supported on the surfaces of the base particles. The polishing agent can be manufactured by steps including: producing the polishing particles (step 1); and manufacturing a polishing agent for a synthetic quartz glass substrate, the polishing agent containing the produced polishing particles and water (step 2).

The step of producing the polishing particles (step 1) includes substeps a to e as follows. Briefly, a solution in which silica particles to serve as the base particles are dispersed is mixed with a solution in which metal salts are dissolved as precursors of the composite oxide particles. The composite oxide particles precipitated by an alkaline solution are supported on the silica particle surfaces. The resulting mixture solution is heated at a temperature of 60° C. or more and 100° C. or less for 1 hour or more. Thus, the polishing particles can be produced.

First, a solution A is prepared in which the silica particles are dispersed in a dispersion medium (substep a). Moreover, a basic solution is prepared as a solution B (substep b). Further, a solution C is prepared in which a cerium salt and a salt of at least one rare earth element selected from trivalent rare earth elements other than cerium are dissolved as the precursors of the composite oxide particles (substep c). These substeps a to c can be performed independently of one another, but the order is not particularly limited, and the substeps a to c may be performed in parallel.

Next, the solution A, the solution B, and the solution C are mixed together to precipitate the composite oxide particles from the precursors of the composite oxide particles, so that the precipitated composite oxide particles are supported on the silica particles (substep d). Then, a solution containing the silica particles on which the composite oxide particles are supported in the substep d is subjected to a heat treatment for 1 hour or more at a solution temperature of 60° C. or more and 100° C. or less (substep e).

More specifically, the polishing particles can be produced as follows.

First, a solution (solution A) in which the silica particles to serve as the base particles are dispersed in a dispersion medium is prepared in a reaction vessel (substep a). The dispersion medium is not particularly limited, but is preferably ultrapure water. As the silica particles, it is possible to use the above-described silica particles or a commercially available colloidal silica slurry in which silica particles have been dispersed in ultrapure water.

A concentration of the silica particles in the dispersion is preferably within a range from 0.01 parts by mass to 50 parts by mass, more preferably within a range from 0.1 parts by mass to 20 parts by mass. The concentration of the silica particles dispersed in the dispersion is preferably 0.01 parts by mass or more because this decreases the number of the composite oxide particles formed but not supported on the silica particles, and increases the proportion of the composite oxide particles supported on the silica particles. Meanwhile, the concentration of the silica particles dispersed in the dispersion is preferably 50 parts by mass or less because this decreases the number of the silica particles not supporting the composite oxide particles, and can increase the concentration of the silica particles supporting the composite oxide.

Moreover, separately from the solution in which the silica base particles are dispersed in the substep a, a precursor solution (solution C) of the composite oxide particles to be supported on the silica base particles is prepared (substep c). Such a composite-oxide precursor solution can be prepared by mixing a cerium salt and a salt of a trivalent rare earth element other than cerium with ultrapure water at a ratio of 2:1 to 4:1. Here, as the cerium salt, at least one of a Ce(III) salt and a Ce(IV) salt can be utilized. As the Ce(III) salt, cerium chloride, cerium fluoride, cerium sulfate, cerium nitrate, cerium carbonate, cerium perchlorate, cerium bromide, cerium sulfide, cerium iodide, cerium oxalate, cerium acetate, and the like can be used. As the Ce(IV) salt, cerium sulfate, ammonium cerium nitrate, cerium hydroxide, and the like can be used. Among these, cerium nitrate is suitably used as the Ce(III) salt, and ammonium cerium nitrate is suitably used as the Ce(IV) salt, in terms of ease of use. Moreover, as the salt of the trivalent rare earth element other than cerium, a nitrate is suitably used.

Further, an acidic solution may be mixed to stabilize the aqueous solution of the composite oxide precursors prepared by mixing with ultrapure water. Here, the acidic solution can be mixed with the composite-oxide precursor solution at a ratio of 1:1 to 1:100. Examples of the acidic solution usable here include hydrogen peroxide, nitric acid, acetic acid, hydrochloric acid, sulfuric acid, and the like. The composite-oxide precursor solution mixed with the acidic solution may be adjusted to have a pH of, for example, 0.01.

Subsequently, separately from the composite-oxide precursor solution, a basic solution (solution B) is prepared (substep b). As the basic solution, ammonia, sodium hydroxide, potassium hydroxide, and the like can be used, and these are mixed with ultrapure water for dilution to an appropriate concentration before use. With respect to the dilution ratio, the basic substance can be diluted with ultrapure water at a ratio of 1:1 to 1:100. The diluted basic solution may be adjusted to have a pH of, for example, 11 to 13.

The diluted basic solution (solution B) is transferred to a reaction vessel storing the solution (solution A) in which the silica base particles are dispersed, and then stirred for, for example, 5 hours or less under an inert gas atmosphere such as nitrogen, argon, or helium. Subsequently, into the reaction vessel, the composite-oxide precursor solution (solution C) prepared in the substep c is poured and mixed at a rate of, for example, 0.1 L/sec or more (substep d). Then, a heat treatment is performed at a predetermined temperature (substep e). In this event, the heat treatment can be performed at a heat treatment temperature of 100° C. or less, for example, 60° C. or more and 100° C. or less. The heat treatment time may be 1 hour or more, for example, 2 hours to 10 hours. Moreover, as the heating rate from normal temperature to the heat treatment temperature, the temperature may be increased at a rate of 0.2° C. to 1° C. per minute, preferably 0.5° C. per minute.

The mixed solution having been subjected to the heat treatment is cooled to room temperature. Through the treatments as described above, the polishing particles are produced in which the composite oxide particles made of ceria and the other rare earth element are supported on the surfaces of the silica base particles.

In addition, the binding force between the silica base particles and the composite oxide particles can be adjusted by the heat treatment time. Increasing the heat treatment time can strengthen the binding force between the silica base particles and the composite oxide particles, while shortening the heat treatment time can weaken the binding force between the silica base particles and the composite oxide particles. When the heat treatment time is sufficiently long, the binding force between the silica base particles and the supported composite oxide particles can be sufficiently ensured, and the detachment of the composite oxide particles from the silica base particles can be prevented during the polishing process. Additionally, the heat treatment time is preferably 1 hour or more and 24 hours or less, more preferably 2 hours or more and 12 hours or less, from the viewpoints that a sufficient heat treatment can be performed and the productivity can be improved.

Further, the particle diameters of the supported composite oxide particles can be adjusted by the heat treatment temperature. There is a trend that the higher the heat treatment temperature, the larger the particle diameters of the composite oxide particles, provided that the heat treatment time is the same. With the temperature of less than 60° C., the particle diameters will not increase even if the heat treatment time is increased. With the temperature of 60° C. or more, increasing the temperature increases the particle diameters. Nevertheless, if the heat treatment temperature is too high, the particle diameters of the composite oxide particles are increased excessively, so that the composite oxide particles may not be supported on the silica base particles. Hence, the heat treatment is performed at a temperature of preferably 60° C. to 100° C., more preferably 70° C. to 90° C., so that the composite oxide particles can grow to have desired particle diameters.

Next, a polishing agent for a synthetic quartz glass substrate is manufactured, the polishing agent containing the polishing particles produced as described above and water (step 2). For example, after the substep e in the step of producing the polishing particles (step 1), the resultant is cooled to room temperature, and the silica particles in the mixed solution are precipitated and then mixed with pure water. Thereby, the inventive polishing agent for a synthetic quartz glass substrate can be manufactured. Additionally, before this mixing, the silica particles may be cleaned by repeating cleaning with pure water and centrifugation. After such cleaning, the polishing particles supporting the composite oxide particles on the surfaces are mixed with water (particularly pure water), so that the inventive polishing agent can be obtained. Furthermore, an additive may be added, or pH adjustment may be appropriately performed as follows.

The inventive polishing agent may contain an additive to adjust the polishing characteristics. Such an additive includes amino acids and anionic surfactants that can change the surface potential of the polishing particles to negative. When the surface potential of the polishing particles is made negative, the particles easily disperse in the polishing agent and do not easily generate secondary particles having large particle diameters, so that generation of polishing damage can be further inhibited.

Examples of the anionic surfactants serving as the additive include monoalkyl sulfate, alkylpolyoxyethylene sulfate, alkylbenzene sulfonate, monoalkyl phosphate, lauryl sulfate, polycarboxylic acid, polyacrylate, polymethacrylate, and the like. Examples of the amino acids include arginine, lysine, aspartic acid, glutamic acid, asparagine, glutamine, histidine, proline, tyrosine, serine, tryptophan, threonine, glycine, alanine, methionine, cysteine, phenylalanine, leucine, valine, isoleucine, and the like.

When these additives are used, the concentration is preferably 0.001 parts by mass or more and 0.05 parts by mass or less per 1 part by mass of the polishing particles, that is, 0.1 parts by mass or more and 5 parts by mass or less per 100 parts by mass of the polishing particles. More preferably, the content is within a range of 0.005 parts by mass to 0.02 parts by mass per 1 part by mass of the polishing particles (0.5 parts by mass or more and 2 parts by mass or less per 100 parts by mass of the polishing particles). When the content is 0.1 parts by mass or more per 100 parts by mass of the polishing particles, the polishing particles more stably disperse in the polishing agent and do not easily form aggregated particles having large particle diameters. Moreover, when the content is 5 parts by mass or less per 100 parts by mass of the polishing particles, the additive does not impede polishing, and can prevent a reduction in the polishing rate. Therefore, the additive contained in the above range can further improve the dispersion stability of the polishing agent while preventing the reduction in the polishing rate.

The inventive polishing agent preferably has a pH within a range of 3.0 or more and 8.0 or less in view of excellent storage stability and polishing rate of the polishing agent. When the pH is 3.0 or more, the polishing particles more stably disperse in the polishing agent. When the pH is 8.0 or less, the polishing rate can be more improved. Moreover, the lower limit of preferable pH range is more preferably 4.0 or more, particularly preferably 6.0 or more. Meanwhile, the upper limit of preferable pH range is preferably 8.0 or less, more preferably 7.0 or less. The pH of the polishing agent can be adjusted by adding: an inorganic acid such as hydrochloric acid, nitric acid, sulfuric acid, or phosphoric acid; an organic acid such as formic acid, acetic acid, citric acid, or oxalic acid; ammonia, sodium hydroxide, potassium hydroxide, tetramethylammonium hydroxide (TMAH), or the like.

Next, a method for polishing a synthetic quartz glass substrate by using the inventive polishing agent will be explained. The inventive polishing agent is particularly preferably used in a finish polishing step after a rough polishing step. Accordingly, the explanation is given by taking, as an example, a case of performing single-side polishing in the finish polishing step. However, it is a matter of course that the present invention is not limited thereto, and the inventive polishing agent can also be used for rough polishing. Moreover, the inventive polishing agent can be used not only for single-side polishing, but also for double-side polishing or the like.

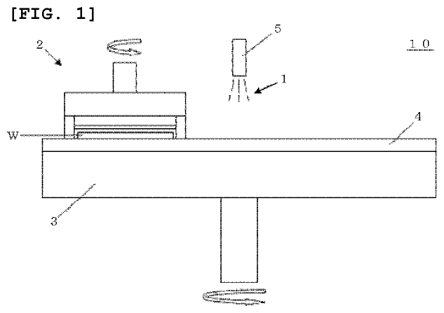

A single-side polishing apparatus usable in the inventive polishing method can be, for example, a single-side polishing apparatus 10 that includes a turn table 3 to which a polishing pad 4 is attached, a polishing agent supply mechanism 5, a polishing head 2, and so forth as shown in FIG. 1. Moreover, as shown in FIG. 1, the polishing head 2 can rotate and hold a synthetic quartz glass substrate W to be polished. Further, the turn table 3 can also rotate. For the polishing pad 4, nonwoven fabric, foamed polyurethane, porous resins, or the like can be used. Further, since the surface of the polishing pad 4 is preferably always covered with a polishing agent 1 during polishing, the polishing agent supply mechanism 5 is preferably provided with a pump or the like to supply the polishing agent 1 successively. In the single-side polishing apparatus 10 as described above, the polishing head 2 holds the synthetic quartz glass substrate W, and the polishing agent supply mechanism 5 supplies the inventive polishing agent 1 onto the polishing pad 4. Then, the turn table 3 and the polishing head 2 are each rotated to bring the surface of the synthetic quartz glass substrate W into sliding contact with the polishing pad 4 for polishing. Such a polishing method using the inventive polishing agent can accelerate the polishing rate and inhibit generation of defects due to polishing. Moreover, the inventive polishing method can provide a synthetic quartz glass substrate having significantly fewer defects and thus is suitably utilizable for finish polishing.

Particularly, a synthetic quartz glass substrate subjected to the finish polishing by the inventive polishing method can be used for semiconductor-related electronic materials (particularly, semiconductor-related electronic materials for cutting-edge application), and can be suitably used for photomask, nanoimprinting, and magnetic devices. Note that a synthetic quartz glass substrate before finish polishing can be prepared, for example, by the following procedure. First, a synthetic quartz glass ingot is formed, and then the synthetic quartz glass ingot is annealed. Next, the synthetic quartz glass ingot is sliced into wafers. Subsequently, the sliced wafers are chamfered and then lapped. Thereafter, the surface of each wafer is polished to a mirror finish. After that, the synthetic quartz glass substrate thus prepared can be subjected to finish polishing by the inventive polishing method.

### EXAMPLE

Hereinafter, the present invention will be more specifically described with reference to Examples of the present invention and Comparative Examples. However, the present invention is not limited to these Examples.

### Example 1

### (Synthesis of Silica Particles Supporting Composite Oxide)

A solution A was prepared by diluting, with 2000 g of ultrapure water, 100 g of a colloidal silica dispersion containing silica particles having an average particle diameter of 80 nm in which the concentration of the silica particles was 20%. The solution A was transferred to a reaction vessel and then stirred. Subsequently, 500 g of ammonia water (solution B) was added dropwise into the reaction vessel and then stirred.

Next, 280 g of diammonium cerium nitrate and 55 g of lanthanum nitrate hexahydrate were dissolved in pure water such that the molar ratio of cerium and lanthanum was 80/20. Thus, a composite-oxide precursor solution was obtained (solution C).

Subsequently, the composite-oxide precursor solution was added dropwise into the reaction vessel, stirred, and heated to 80° C. under a nitrogen gas atmosphere. The heat treatment was performed for 8 hours to obtain a mixed solution containing the silica particles and composite oxide particles supported on the surfaces of the silica particles.

After the mixed solution containing the silica particles supporting the composite oxide particles on the surfaces was cooled to room temperature, the silica particles in the mixed solution were precipitated. Then, several cleaning operations with pure water and centrifugation were repeated to clean the silica particles. Finally, polishing particles were obtained on the surfaces of which the composite oxide particles were supported.

Additionally, the average particle diameter of the composite oxide particles finally obtained was adjusted by adjusting the heating temperature.

### (Manufacturing Polishing Agent for Synthetic Quartz Glass Substrate)

The polishing particles synthesized as described above were prepared in a total amount of 500 g. Next, 500 g of these polishing particles were mixed with 5 g of sodium polyacrylate (manufactured by Wako Pure Chemical Industries, Ltd.) and 5000 g of pure water. A potassium hydroxide solution was added dropwise to the mixture to adjust the pH to 6.0. Subsequently, the resultant was ultrasonically dispersed for 60 minutes under stirring. The resulting slurry was filtered through a 0.5-μm filter. Thus, a polishing agent for polishing a synthetic quartz glass substrate was prepared which contained 0.1 mass % sodium polyacrylate and the polishing particles at a concentration of 10 mass %. According to the measurement under an electron microscope, the polishing particles had an average particle diameter of 100 nm. Moreover, the composite oxide particles supported on the silica particles had an average particle diameter of 10 nm.

### (Polishing Synthetic Quartz Glass Substrate)

A synthetic quartz glass substrate was set to a polishing apparatus and polished under the following polishing conditions using the polishing agent prepared as described above.

First, as a turn table for polishing, a turn table with a polishing pad (made of soft suede/manufactured by FILWEL Co., Ltd.) attached thereto was prepared. Moreover, a synthetic quartz glass substrate having a diameter of 4 inches (about 100 mm) after rough polishing was set to a substrate-mountable head such that the surface to be polished faced downward. Using these, the synthetic quartz glass substrate was polished by 2 μm or more, which is an amount sufficient to remove the defect generated in the rough polishing step, while the polishing agent for polishing a synthetic quartz glass substrate was being supplied in an amount of 100 ml per minute. In this event, the polishing load was 100 gf/cm² (about 9.8 kPa), and the rotation speed of the turn table and the head was 50 rpm. After the polishing, the synthetic quartz glass substrate was taken from the head, washed with pure water, further subjected to ultrasonic cleaning, and then dried at 80° C. with a drier. The change in thickness of the synthetic quartz glass substrate before and after the polishing was measured with a reflection spectroscopic film thickness monitor (SF-3 manufactured by OTSUKA Electronics Co., Ltd.) to calculate the polishing rate. In addition, the number of defects of 100 nm or larger generated on the surface of the polished synthetic glass substrate was counted with a laser microscope.

The polishing rate obtained based on the change in thickness of the synthetic quartz glass substrate before and after the polishing was 3.0 μm/hr. The number of defects on the polished surface of the synthetic quartz glass substrate found with the laser microscope was two.

### Example 2

A polishing agent was prepared by the same procedure as in Example 1, except that a colloidal silica dispersion containing silica having an average particle diameter of 50 nm was used. The average particle diameter measured with the electron microscope was 70 nm. Moreover, the composite oxide particles supported on the silica particles had an average particle diameter of 10 nm. This polishing agent was used to polish a synthetic quartz glass substrate through the same operations as in Example 1. As a result, the polishing rate was 1.0 μm/hr, and the number of defects was one.

### Example 3

A polishing agent was prepared by the same procedure as in Example 1, except that a colloidal silica dispersion containing silica having an average particle diameter of 120 nm was used. The average particle diameter measured with the electron microscope was 140 nm. Moreover, the composite oxide particles supported on the silica particles had an average particle diameter of 10 nm. This polishing agent was used to polish a synthetic quartz glass substrate through the same operations as in Example 1. As a result, the polishing rate was 5.0 μm/hr, and the number of defects was nine.

Table 1 shows the above-described results of Examples 1 to 3. Note that the numbers in the table each indicate an average value of five synthetic quartz glass substrates polished in each of Examples 1 to 3.

TABLE 1

| | | | | Average particle | | |
|---|---|---|---|---|---|---|
| | Content ratio (mol %) in | | Average particle | diameter (nm) of | Polishing | |
| | supported composite oxide | | diameter (nm) of | composite oxide | rate | Defect |
| | cerium | lanthanum | base silica particles | particles | (μm/hr) | (number) |
| Example 1 | 80 | 20 | 80 | 10 | 3.0 | 2 |
| Example 2 | 80 | 20 | 50 | 10 | 1.0 | 1 |
| Example 3 | 80 | 20 | 120 | 10 | 5.0 | 9 |

As shown in Table 1, when the synthetic quartz glass substrates were polished using the polishing agent of Example 1, that is, the silica base particles of predetermined sizes, generation of defects due to polishing were successfully inhibited. Further, high polishing rate was obtained for the synthetic quartz glass substrates.

Meanwhile, in Example 2, the silica base particles had smaller sizes than those in Example 1, and consequently the polishing rate was lower. In Example 3, the silica base particles had larger sizes that those in Example 1, and consequently the polishing agent exhibited a higher polishing rate, but resulted in more defects. In Example 2, the polishing rate is low but the number of defects is significantly small in comparison with Example 1; thus, the polishing agent of Example 2 is within a practice range. In Example 3, the number of defects is large but the polishing rate is significantly high in comparison with Example 1; thus, the polishing agent of Example 3 is within a practice range.

### Example 4

A polishing agent was obtained by the same procedure as in Example 1, except that the content ratio (molar ratio) of cerium/lanthanum in the composite oxide particles supported on the silica base particles was 50/50 mol %. The obtained polishing agent was measured with the electron microscope, and the average particle diameter was 100 nm.

This polishing agent was used to polish a synthetic quartz glass substrate through the same operations as in Example 1. As a result, the polishing rate was 3.6 μm/hr, and the number of defects was four.

### Example 5

A polishing agent was prepared by the same procedure as in Example 1, except that the content ratio (molar ratio) of cerium/lanthanum in the composite oxide particles supported on the silica base particles was 60/40 mol %. The obtained polishing agent was measured with the electron microscope, and the average particle diameter was 100 nm.

This polishing agent was used to polish a synthetic quartz glass substrate through the same operations as in Example 1. As a result, the polishing rate was 3.4 μm/hr, and the number of defects was four. [Example 6]

A polishing agent was prepared by the same procedure as in Example 1, except that the heating temperature was 60° C. in the process of supporting the composite oxide onto the silica base particles. The obtained polishing agent was measured with the electron microscope, and the polishing particles had an average particle diameter of 85 nm. Moreover, the composite oxide particles supported on the silica particles had an average particle diameter of 1 nm.

This polishing agent was used to polish a synthetic quartz glass substrate through the same operations as in Example 1. As a result, the polishing rate was 2.5 μm/hr, and the number of defects was two.

### Example 7

A polishing agent was prepared by the same procedure as in Example 1, except that the heating temperature was 90° C. in the process of supporting the composite oxide onto the silica base particles. The obtained polishing agent was measured with the electron microscope, and the polishing particles had an average particle diameter of 120 nm. Moreover, the composite oxide particles supported on the silica particles had an average particle diameter of 20 nm.

This polishing agent was used to polish a synthetic quartz glass substrate through the same operations as in Example 1. As a result, the polishing rate was 4.0 μm/hr, and the number of defects was eight.

### Example 8

A polishing agent was prepared by the same procedure as in Example 1, except that the content ratio (molar ratio) of cerium/lanthanum in the composite oxide particles supported on the silica base particles was 90/10 mol %. The obtained polishing agent was measured with the electron microscope, and the polishing particles had an average particle diameter of 100 nm. Moreover, the composite oxide particles supported on the silica particles had an average particle diameter of 10 nm.

This polishing agent was used to polish a synthetic quartz glass substrate through the same operations as in Example 1. As a result, the polishing rate was 1.8 μm/hr, and the number of defects was five.

### Example 9

A polishing agent was prepared by the same procedure as in Example 1, except that the content ratio (molar ratio) of cerium/lanthanum in the composite oxide particles supported on the silica base particles was 30/70 mol %. The obtained polishing agent was measured with the electron microscope, and the polishing particles had an average particle diameter of 90 nm. Moreover, the composite oxide particles supported on the silica particles had an average particle diameter of 5 nm.

This polishing agent was used to polish a synthetic quartz glass substrate through the same operations as in Example 1. As a result, the polishing rate was 1.5 μm/hr, and the number of defects was five.

### Comparative Example 1

A polishing agent was prepared by the same procedure as in Example 1, except that the particles supported on the silica base particles had a composition of 100% ceria. The obtained polishing agent was measured with the electron microscope, and the polishing particles had an average particle diameter of 110 nm. Moreover, the ceria particles supported on the silica particles had an average particle diameter of 15 nm.

This polishing agent was used to polish a synthetic quartz glass substrate through the same operations as in Example 1. As a result, the polishing rate was 1.2 μm/hr, and the number of defects was six.

### Comparative Example 2

A polishing agent was prepared by the same procedure as in Example 1, except that the particles supported on the silica base particles had a composition of 100% lanthanum oxide. The obtained polishing agent was measured with the electron microscope, and the polishing particles had an average particle diameter of 90 nm. Moreover, the lanthanum oxide particles supported on the silica particles had an average particle diameter of 5 nm.

This polishing agent was used to polish a synthetic quartz glass substrate through the same operations as in Example 1. As a result, the polishing rate was 0.9 μm/hr, and the number of defects was five.

### Comparative Example 3

### (Synthesis of Cerium-Lanthanum Composite Oxide Particles)

A solution obtained by diluting 1000 g of an ammonia solution with 5000 g of ultrapure water was transferred to a reaction solution and then stirred.

Next, 1000 g of cerium nitrate hexahydrate, 1 g of diammonium cerium nitrate, and 300 g of lanthanum nitrate hexahydrate were dissolved in pure water such that the molar ratio of cerium and lanthanum was 80/20=4.0. Thus, a mixed solution of cerium and lanthanum was obtained.

Subsequently, the mixed solution of cerium and lanthanum was added dropwise into the reaction vessel, stirred, and heated to 80° C. under a nitrogen gas atmosphere. The heat treatment was performed for 8 hours to obtain a mixed solution containing cerium-lanthanum composite oxide particles. According to the electron microscope measurement, the cerium-lanthanum composite oxide particles had an average particle diameter of 10 nm.

After the mixed solution containing the cerium-lanthanum composite oxide particles was cooled to room temperature, the composite oxide particles in the mixed solution were precipitated. Then, several cleaning operations with pure water and centrifugation were repeated to clean the composite oxide particles. Finally, the cerium-lanthanum composite oxide particles were obtained. The particles are particles composed of the composite oxide particles alone, and the base particles were not silica particles.

The polishing particles (cerium-lanthanum composite oxide particles) synthesized according to the above-described procedure were mixed with a colloidal silica dispersion containing silica particles having an average particle diameter of 80 nm, and diluted with pure water. Thus, a polishing agent was prepared which contained the silica particles and the composite oxide particles both as the polishing particles in a total amount of 10 parts by mass.

This polishing agent was used to polish a synthetic quartz glass substrate through the same operations as in Example 1. As a result, the polishing rate was 1.0 μm/hr, and the number of defects was five.

Table 2 shows the above-described results of Examples 4 to 9 and Comparative Examples 1 to 3. Note that the numbers in the table each indicate an average value of five synthetic quartz glass substrates polished in each of Examples and Comparative Examples.

TABLE 2

| | | | | Average particle | | |
|---|---|---|---|---|---|---|
| | Content ratio (mol %) in | | Average particle | diameter (nm) of | Polishing | |
| | supported composite oxide | | diameter (nm) of | composite oxide | rate | Defect |
| | cerium | lanthanum | base silica particles | particles | (μm/hr) | (number) |
| Example 4 | 50 | 50 | 80 | 10 | 3.6 | 4 |
| Example 5 | 60 | 40 | 80 | 10 | 3.4 | 4 |
| Example 6 | 80 | 20 | 80 | 1 | 2.5 | 2 |
| Example 7 | 80 | 20 | 80 | 20 | 4.0 | 8 |
| Example 8 | 90 | 10 | 80 | 10 | 1.8 | 5 |
| Example 9 | 30 | 70 | 80 | 5 | 1.5 | 5 |
| Comparative | 100 | 0 | 80 | 15 (ceria | 1.2 | 6 |
| Example 1 | | | | particles) | | |
| Comparative | 0 | 100 | 80 | 5 (lanthanum | 0.9 | 5 |
| Example 2 | | | | oxide particles) | | |
| Comparative | 80 | 20 | 80 (alone) | 10 (alone) | 1.0 | 5 |
| Example 3 | | | | | | |

When the synthetic quartz glass substrates were polished using the polishing agents of Examples 4 to 9, that is, the inventive polishing agent containing, as the polishing abrasive grains, the silica base particles supporting the composite oxide particles containing cerium and a trivalent rare earth element other than cerium, generation of defects due to polishing were successfully inhibited. Further, high polishing rates were obtained for the synthetic quartz glass substrates. On the other hand, even when particles were supported on silica base particles as in Comparative Examples 1, 2, if the supported particles were not the composite oxide particles as in the present invention, the polishing rates were lower.

Moreover, in Examples 4 to 7 where the molar ratio of cerium and lanthanum in the supported composite oxide particles satisfied 1.0 to 4.0, the polishing rates for the synthetic quartz glass substrates were higher than those in Example 8 where the molar ratio was higher than 4.0 and Example 9 where the molar ratio was lower than 1.0.

Further, the polishing agent of Comparative Example 3 prepared by simply mixing the silica particles and the ceria composite oxide particles exhibited a low polishing rate in comparison with Example 1 where the composite oxide particles were supported on the silica particles.

As has been described above, when a synthetic quartz glass substrate is polished with the inventive polishing agent for polishing a synthetic quartz glass substrate, high polishing rate is achieved for the synthetic quartz glass substrate, and the synthetic quartz glass substrate can be polished with few defects generated on the polished surface.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1.-9. (canceled)

10. A polishing agent for a synthetic quartz glass substrate, comprising polishing particles and water, wherein
the polishing particles comprise silica particles as base particles, and
composite oxide particles of cerium and at least one rare earth element selected from trivalent rare earth elements other than cerium are supported on surfaces of the base particles.

11. The polishing agent for a synthetic quartz glass substrate according to claim 10, wherein
the base particles comprise amorphous silica particles, and
the amorphous silica particles have an average particle diameter of 60 nm or more and 120 nm or less.

12. The polishing agent for a synthetic quartz glass substrate according to claim 10, wherein
the composite oxide particles are a composite oxide of cerium and lanthanum, and
a molar ratio of cerium/lanthanum is 1.0 to 4.0.

13. The polishing agent for a synthetic quartz glass substrate according to claim 11, wherein
the composite oxide particles are a composite oxide of cerium and lanthanum, and
a molar ratio of cerium/lanthanum is 1.0 to 4.0.

14. The polishing agent for a synthetic quartz glass substrate according to claim 10, wherein the composite oxide particles have particle diameters of 1 nm or more and 20 nm or less.

15. The polishing agent for a synthetic quartz glass substrate according to claim 11, wherein the composite oxide particles have particle diameters of 1 nm or more and 20 nm or less.

16. The polishing agent for a synthetic quartz glass substrate according to claim 12, wherein the composite oxide particles have particle diameters of 1 nm or more and 20 nm or less.

17. The polishing agent for a synthetic quartz glass substrate according to claim 13, wherein the composite oxide particles have particle diameters of 1 nm or more and 20 nm or less.

18. The polishing agent for a synthetic quartz glass substrate according to claim 10, wherein a concentration of the polishing particles is 5 parts by mass or more and 30 parts by mass or less per 100 parts by mass of the polishing agent for a synthetic quartz glass substrate.

19. The polishing agent for a synthetic quartz glass substrate according to claim 11, wherein a concentration of the polishing particles is 5 parts by mass or more and 30 parts by mass or less per 100 parts by mass of the polishing agent for a synthetic quartz glass substrate.

20. The polishing agent for a synthetic quartz glass substrate according to claim 12, wherein a concentration of the polishing particles is 5 parts by mass or more and 30 parts by mass or less per 100 parts by mass of the polishing agent for a synthetic quartz glass substrate.

21. The polishing agent for a synthetic quartz glass substrate according to claim 13, wherein a concentration of the polishing particles is 5 parts by mass or more and 30 parts by mass or less per 100 parts by mass of the polishing agent for a synthetic quartz glass substrate.

22. The polishing agent for a synthetic quartz glass substrate according to claim 14, wherein a concentration of the polishing particles is 5 parts by mass or more and 30 parts by mass or less per 100 parts by mass of the polishing agent for a synthetic quartz glass substrate.

23. The polishing agent for a synthetic quartz glass substrate according to claim 15, wherein a concentration of the polishing particles is 5 parts by mass or more and 30 parts by mass or less per 100 parts by mass of the polishing agent for a synthetic quartz glass substrate.

24. The polishing agent for a synthetic quartz glass substrate according to claim 16, wherein a concentration of the polishing particles is 5 parts by mass or more and 30 parts by mass or less per 100 parts by mass of the polishing agent for a synthetic quartz glass substrate.

25. The polishing agent for a synthetic quartz glass substrate according to claim 17, wherein a concentration of the polishing particles is 5 parts by mass or more and 30 parts by mass or less per 100 parts by mass of the polishing agent for a synthetic quartz glass substrate.

26. The polishing agent for a synthetic quartz glass substrate according to claim 10, further comprising an additive, wherein
a concentration of the additive is 0.1 parts by mass or more and 5 parts by mass or less per 100 parts by mass of the polishing particles.

27. The polishing agent for a synthetic quartz glass substrate according to claim 10, wherein the polishing agent has a pH of 3.0 or more and 8.0 or less.

28. A method for polishing a synthetic quartz glass substrate, comprising a rough polishing step and a finish polishing step after the rough polishing step, wherein the polishing agent for a synthetic quartz glass substrate according to claim 10 is used in the finish polishing step for final polishing.

29. A method for manufacturing a polishing agent for a synthetic quartz glass substrate, wherein
the polishing agent comprises water and polishing particles comprising silica particles as base particles,
composite oxide particles of cerium and at least one rare earth element selected from trivalent rare earth elements other than cerium are supported on surfaces of the base particles, and
the method comprises:
a step of producing the polishing particles, the step comprising
a substep of preparing a solution A in which the silica particles are dispersed in a dispersion medium,
a substep of preparing a basic solution as a solution B,
a substep of preparing a solution C in which a cerium salt and a salt of at least one rare earth element selected from trivalent rare earth elements other than cerium are dissolved as precursors of the composite oxide particles,
a substep of mixing the solution A, the solution B, and the solution C to precipitate the composite oxide particles from the precursors of the composite oxide particles, so that the precipitated composite oxide particles are supported on the silica particles, and
a substep of subjecting a solution containing the silica particles on which the composite oxide particles are supported to a heat treatment for 1 hour or more at a solution temperature of 60° C. or more and 100° C. or less; and
a step of manufacturing a polishing agent for a synthetic quartz glass substrate, the polishing agent comprising the produced polishing particles and water.
